(19) United States
(12) Patent Application Publication
(10) Pub. No.: US 2011/0033671 A1
(43) Pub. Date: Feb. 10, 2011

(54) High Strength Environmentally Friendly Contoured Articles

(76) Inventors: Patrick Govang, Ithaca, NY (US); Anil Netravali, Ithaca, NY (US)

Correspondence Address: Jaekle Fleischmann & Mugel, LLP, 12 Fountain Plaza, Buffalo, NY, 14202-2292, US

(21) Appl. No.: 12/818,146

(22) Filed: Jun. 17, 2010

(30) Foreign Application Priority Data
Dec. 17, 2008 (US) PCT/US08/87239

(51) Int. Cl. B32B 9/02; B29C 67/24; B32B 1/00

(52) U.S. Cl. 428/174; 264/257

(57) ABSTRACT

The present invention is a contoured press molded article comprising:
a soy-based resin and a plant-based sheet, wherein the article is manufactured from the process comprising the steps of:
impregnating the sheet with soy-based resin;
precuring the sheet to remove water to form a premolded article wherein at least one region of a premolded article is reinforced with at least one additional layer of impregnated soy-based resin;
pressing the premolded article into a contoured molded article, wherein the contoured molded article has a flexural strength that is greater than 20 MPas.

### CROSS REFERENCE TO RELATED APPLICATIONS

This application claims priority under 35 USC 371 to PCT/US08/87239 filed Dec. 17, 2008 and claims the benefit of U.S. Provisional 61/014,209 filed Dec. 17, 2007, which is incorporated herein by reference.

### FIELD OF THE INVENTION

The present invention, generally, relates to contoured articles that are biodegradable and free of formaldehyde and more particularly to contoured articles with soy based resin systems.

### BACKGROUND OF THE INVENTION

Urea-Formaldehyde (UF) resins are widely used as a binder for use in oriented strand board and particle board. These formaldehyde-based resins are inexpensive, colorless, and are able to cure fast to form a rigid polymer. Despite the effectiveness of the UF resins, particle board and oriented strand board often has a reputation for being of poor quality. Included in the quality is concern about the rate that these composites degrade when exposed to water or heat and humidity.

Another serious disadvantage of UF resin-bonded wood products is that they slowly emit formaldehyde into the surrounding environment. Formaldehyde is a know carcinogen and is part of a class of compounds that are commonly known as Volatile Organic Compounds (VOCs). Due to environmental, health, and regulatory issues related to formaldehyde emissions from wood products, there is a continuing need for alternative formaldehyde-free binders. Recent legislation has prohibited or severely restricted the use of formaldehyde in furniture and building materials in one or more states.

A number of formaldehyde-free compositions have been developed for use as a binder for making wood products. U.S. Pat. No. 4,395,504 discloses the use of formaldehyde-free adhesive system prepared by a reaction of a cyclic urea with glyoxal, for the manufacture of particleboard. Such a system, however, showed a rather slow cure and required acidic conditions (low pH) for the cure.

U.S. Pat. No. 5,059,488 shows an advantage of glutaraldehyde over glyoxal, when used in a reaction with cyclic urea. The patent discloses the use of glutaraldehyde-ethylene urea resins for wood panel manufacture. It was shown that this resin cured faster than glyoxal-ethylene urea resin, and the cure can be performed at a relatively high pH. However, the glutaraldehyde-based resins are not economically feasible.

U.S. Pat. No. 4,692,478 describes a formaldehyde-free binder for particleboard and plywood prepared of carbohydrate raw material such as whey, whey permeate, starch and sugars. The process comprises hydrolysis of the carbohydrate by a mineral acid, and then neutralizing the resin by ammonia. Although the raw materials are cheap and renewable, the reaction has to be performed at about 0.5. The pH makes handling difficult, dangerous, and costly.

U.S. Pat. No. 6,822,042 also discloses the use of a carbohydrate material (corn syrup) for preparing a non-expensive wood adhesive. Advantages of this binder include strong bonding, low cost, and renewable raw material. However, this adhesive requires the use of isocyanate as a cross-linker for this composition. Isocyanates are toxic making the use as a substitute for formaldehyde undesirable.

U.S. Pat. No. 6,599,455 describes a formaldehyde-free binder for producing particleboard containing curable thermoplastic co-polymers and cross-linkers selected from epoxy, isocyanate, N-methylol and ethylene carbonate compounds. Such compositions provide good strength and water resistance when cured. The epoxys are economically unfeasible do to the high material cost.

U.S. Pat. No. 6,348,530 describes a formaldehyde-free binder for producing shaped wood articles comprising a mixture of hydroxyalkylated polyamines and polycarboxylic acids. The binder preparation requires difficult steps to product and as a result is not economically viable.

One product that has emerged as a substitute for formaldehyde products is Purebond® proprietary manufacturing system for hardwood, plywoods and particle board. However, it is believed that Purebond® may include other toxic chemicals such as epichlorohydrin. While Purebond® is an improvement over the state of the art, it ultimately does not eliminate all dangerous or potentially dangerous compounds from its formulation. See http://www.columbiaforestproducts.com/products/prodpb.aspx. See also U.S. Pat. No. 7,252,735. U.S. Pat. No. 7,345,136 (Heartland Resources Technologies) is believed to relate to H2H proprietary product, Soyad®. Soyad® is believed to include soy protein in a resin form, but does not eliminate the use of carcinogenic binders in combination with the soy protein.

Thus, after considerable attempts to solve the problem of urea formaldehyde adhesives, there exists a need to create a truly non-toxic high strength resin or composite system that does not contain any formaldehyde compositions or other carcinogenic compounds, is earth friendly and remarkably strong.

One other disadvantage of wood, plant or other lignocellulosic material is that while they have found commercial acceptance in panels, they have not bee effectively used in molding contoured articles.

Flexform Technologies, Inc. (www.flexformtech.com) produces a nonwoven natural fiber such as hemp or flax that is produced with polypropylene as a binder. The mats are sold in an uncompressed state as matts. It is also compressed to form automobile door panels, medium and high density boards. However, effective the matts are, they are not biodegradable. Thus, there remains a need for fully biodegradable composite materials that are easily formed into contoured articles.

The state of the art is to find a resin that would be an effective replacement of formaldehyde resins. However, it would be desirable to provide a board that exceeds the current state of the art of particle board in strength. It would be further advantageous if this material was biodegradable, substantially, if not entirely from renewable sources, was environmentally friendly. It would be advantageous if the material were of a form that is well suited for shape molded articles that are pressed in forms that are contoured and yet rigid and strong when molding is completed. It is desirable that such curable compositions contain relatively high amount of non-volatiles, and at the same time are stable, fast-curing and do not emit any toxic fumes during the cure and afterwards. It would be desirable for the product to be not harmful to the environment when placed in a landfill. The present invention addresses one or more these and other needs.

### SUMMARY OF THE INVENTION

The present invention includes a contoured press molded article. The contoured press molded article comprises a soy-based resin and a plant-based sheet. The article is manufactured from the process comprising the step of impregnating the sheet with soy-based resin. The process further includes precuring the sheet to remove water to form a premolded article. At least one region of the premolded article is reinforced with at least one additional layer of impregnated soy-based resin to impart properties of greater strength or stiffness. The premolded article is then pressed into a contoured molded article, wherein the contoured molded article has a flexural strength that is greater than 20 MPas and the region of the article has properties of greater strength or stiffness relative to the other parts of the article.

In one embodiment, there is a process of making contoured articles, comprising the step of impregnating a plant-based sheet with a soy-based resin. The impregnated sheet is precured to remove water and form a premolded article. A region of the contoured premolded article is reinforced with at least one additional sheet layer. The process further includes a step of pressing the premolded article into a contoured molded article that has three-dimensional contours, wherein the precured article has a flexural strength that is greater than 20 MPas and the region has greater strength and/or stiffness properties.

In one embodiment, the region defines a curve in the contoured article. In another embodiment, the region defines an area of anticipated greater flexural wear in the contoured article.

One additional advantage of the present invention is that in one embodiment, the article will not harm the environment when decomposed.

In another embodiment, the process further comprises the step of cutting the molded article into its desired shape. Typically, the process includes a further step of finishing the edges of the molded article.

In still another embodiment, the process further comprises coating the article with a water-proofing agent that will not harm the environment when decomposed.

In yet another embodiment, the step of coating results in a coating of desired color and appearance.

In still another embodiment, the step of precuring further includes precuring in a contoured premold to form a precured article, wherein the contoured premold is the general contour of the molded article.

In still another embodiment, the resin further comprises a carboxy-containing polysaccharide copolymer. In another embodiment, the resin is substantially free of starch.

In one embodiment, the article is a door panel, dashboard, wall panel or ceiling panel of a vehicle such as an automobile, train, boat or airplane. In another embodiment, the article is a chair, couch, table, shelf or cabinet. In one preferred embodiment, the article is a door panel and the region is adjacent the door handle. In another preferred embodiment, the article is a chair or couch and the region is the point that connects the back to the seat.

In yet another embodiment, wherein the process includes an additional step of coating the article with a water-proofing agent that will not harm the environment when decomposed.

In one embodiment, the step of precuring further includes precuring in a premold to form a precured sheet, wherein the premold is the general contour of the molded article.

In another embodiment, the surface area of the article is greater than about 3 ft² preferably about 4 ft², more preferably about 5 ft², even more preferably about 6 ft².

In another embodiment, the article was compressed from two or more sheets of uniform thickness that are individually impregnated with a coating of uniform thickness, wherein the weight ratio of resin to the sheets is a minimum of 1:1.

### BRIEF DESCRIPTION OF THE DRAWINGS

FIG. 1 is a perspective drawing of a shape-molded bucket seat according to an embodiment of the invention.

FIG. 2 is a perspective drawing of a mold and impregnated fiber sheet prior to molding.

FIG. 3 is a side view of a table with a contoured table-top design according to one embodiment of the invention.

FIG. 4 is a bottom view of the table of FIG. 3.

FIG. 5 is a sectional view of the table of FIG. 4 taken along the line 5-5.

FIG. 6. is a mold for creating the table top design of FIG. 3.

FIG. 7 is an exploded view of all of the layers of a snowboard having a core manufactured according to one embodiment of the present invention.

### DETAILED DESCRIPTION OF THE INVENTION

### Definitions

The term “biodegradable” is used herein to mean degradable over time by water, microbes and/or enzymes found in nature (e.g. compost), without harming the environment. To be considered strictly biodegradable a material is required to degrade a minimum of 60% within 180 days under compostable conditions that are defined by ASTM D790.

The terms “biodegradable resin” and “biodegradable composite” are used herein to mean that the resin and composite are sustainable and at the end of their useful life, can be disposed of or composted without harming, and in fact helping, the environment.

The term, “contour” as used herein refers to a shape that is not strictly planar.

The term “stress at maximum load” means the stress at load just prior to fracture, as determined by the stress-strain curve in a tensile test.

The term “fracture stress” means the stress at fracture as determined by the stress-strain curve in a tensile test.

The term “fracture strain” means the strain (displacement) at fracture, as determined by the stress-strain curve in a tensile test.

The term “modulus” means stiffness, as determined by the initial slope of the stress-strain curve in a tensile test.

The term “toughness” means the amount of energy used in fracturing the material, as determined by the area under the stress-strain curve.

The “tensile test” referred to is carried out using Instron or similar testing device according to the procedure of ASTM Test No. D882 for resin sheets and D3039 for composites. Testing is carried out after 3 days conditioning at 21° C. and 65% relative humidity.

The term “strengthening agent” is used herein to describe a material whose inclusion in the biodegradable polymeric composition of the present invention results in an improvement in any of the characteristics “stress at maximum load”, “fracture stress”, “fracture strain”, “modulus”, and “toughness” measured for a solid article formed by curing of the composition, compared with the corresponding characteristic measured for a cured solid article obtained from a similar composition lacking the strengthening agent.

The term “curing” is used herein to describe subjecting the composition of the present invention to conditions of temperature and effective to form a solid article having a moisture content of preferably less than about 0.5 wt. %.

The phrase “free of formaldehyde” or “formaldehyde free” means the materials used do not contain formaldehyde or a compound that will release formaldehyde in the manufacturing process or during the effective life of the product.

### The Fiber Mats or Sheets

In accordance with the present invention, the soy impregnated fiber mat plies are made of biodegradable fiber mats or sheets and biodegradable polymeric resin that comprises soy protein. Preferably the mats and sheets are biodegradable and from a renewable natural resource.

In one embodiment, the mats or sheets are woven or nonwoven fabrics made of any biodegradable material that has fibers useful in making fabric, cords or string. In one embodiment, the biodegradable fibers are made of cotton, silk, spider silk, hemp, ramie, kenaf, burlap, flax, sisal, sorghum, kapok, banana, pineapple wool, hair or fur, jute, polylactic acid (PLA), viscose rayon, lyocell, or combinations thereof.

In one embodiment, the fabrics are preferably hemp, ramie, sorghum, kenaf, burlap, jute, flax, sisal, kapok, banana or pineapple fibers.

In an embodiment, the fibers are yarn, woven, nonwoven, knitted or braided. The mats are preferably of uniform thickness and water absorbent to facilitate easy impregnation of the mats by soy based resin. In one embodiment the mats are nonwoven and have a mass per area that is a minimum of about 100 g/m², about 200 g/m² or about 300 g/m² and/or a maximum of about 500 g/m², about 600 g/m² or about 800 g/m².

In one preferred embodiment, the mats are nonwoven and are made of natural fibers (e.g. kenaf fibers) that are blended with a binding fiber that will bind to the natural fibers under conditions of heat and pressure. One example of a binding fiber is poly(lactic acid). Poly(lactic acid) fibers are blended with the natural fibers. The blended fibers are heat pressed. The poly (lactic acid) readily melts during the heat press stage and binds the kenaf fibers together. Degradable fibers that are capable of binding to natural fibers to form a workable mat include wool, viscose rayon, lyocell, and poly(lactic acid) and combinations thereof.

In one embodiment, the non-woven mats comprise, prior to impregnation, a binding fiber in an amount that is a minimum of about 1 wt. %, about 2 wt. %, about 5 wt. %, about 7 wt. % and/or a maximum of about 20 wt. %, about 17 wt. %, about 15 wt. %, about 12 wt. % or about 10 wt. %. Optionally, the non-woven mats comprise, prior to impregnation, natural fiber that is a minimum of about 80 wt. %, about 82 wt. %, about 85 wt. %, about 87 wt. % or about 90 wt. %.

### Resin

In one embodiment, the resin includes soy protein and a soluble strengthening agent (i.e., substantially soluble in water at a pH of about 7.0 or higher. In one embodiment, the soluble strengthening agent is a polysaccharide. Preferably, the polysaccharide is a carboxy-containing polysaccharide. In one preferred embodiment, the soluble strengthening agent is selected from the group consisting of agar agar, agar, gellan, and mixtures thereof.

Soy protein is the basis for the resin of the present invention. Soy protein can be obtained in soy flour, soy protein concentrate and soy protein isolate. Each of these sources has increasing concentrations of soy protein. Preferably, soy protein concentrate is used because of it has an excellent tradeoff between cost and concentration of soy protein.

The amount of soy protein added to the fiber mats, fabrics, or yarns, results in composite panels that have a minimum of about 30 wt. % soy protein, about 35 wt. % soy protein, about 40 wt. % soy protein, about 50 wt. % soy protein and/or a maximum of about 70 wt. % soy protein, about 65 wt. % soy protein, about 60 wt. % soy protein, about 55 wt. % soy protein or about 50 wt. % soy protein based upon the final weight of the finished panel.

Soy protein has been modified in various ways and used as resin in the past, as described in, for example, Netravali, A. N. and Chabba, S., Materials Today, pp. 22-29, April 2003; Lodha, P. and Netravali, A. N., Indus. Crops and Prod. 2005, 21, 49; Chabba, S, and Netravali, A. N., J. Mater. Sci. 2005, 40, 6263; Chabba, S, and Netravali, A. N., J. Mater. Sci. 2005, 40, 6275; and Huang, X. and Netravali, A. N., Biomacromolecules, 2006, 7, 2783.

Soy protein contains about 20 different amino acids, including those that contain reactive groups such as —COOH, —NH₂ and —OH groups. Once processed, soy protein itself can form crosslinks through the —SH groups present in the cysteine amino acid as well as through the dehydroalanine (DHA) residues formed from alanine by the loss of side chain beyond the β-carbon atom. DHA is capable of reacting with lysine and cysteine by forming lysinoalanine and lanthionine crosslinks, respectively. Asparagines and lysine can also react together to form amide type linkages. All these reactions can occur at higher temperatures and under pressure that is employed during curing of the soy protein.

In addition to the self-crosslinking in soy protein, the reactive groups can be utilized to modify soy proteins further to obtain desired mechanical and physical properties. The most common soy protein modifications include: addition of crosslinking agents and internal plasticizers, blending with other resins, and forming interpenetrating networks (IPN) with other crosslinked systems. Without being limited to a particular mechanism of action, these modifications are believed to improve the mechanical and physical properties of the soy resin.

The properties (mechanical and thermal) of the soy resins can be further improved by adding nanoclay particles and micro- and nano-fibrillar cellulose (MFC, NFC), as described in, for example, Huang, X. and Netravali, A. N., “Characterization of flax yarn and flax fabric reinforced nano-clay modified soy protein resin composites,” Compos. Sci. and Technol., in press, 2007; and Netravali, A. N.; Huang, X.; and Mizuta, K., “Advanced green Composites,” Advanced Composite Materials, submitted, 2007.

The resin can include additional non-soluble strengthening agents of natural origin that can be a particulate material, a fiber, or combinations thereof. The non-soluble strengthening agent may be, for example, a liquid crystalline (LC) cellulose nanoclay, microfibrillated cellulose, nanofibrillated cellulose.

Further in accordance with the present invention, a composition containing agar, gellan or agar and soy protein can be optionally employed together with natural and high strength liquid crystalline (LC) cellulosic fibers to form biodegradable composites. The LC cellulose fibers can be produced by dissolving cellulose in highly concentrated phosphoric acid to form a LC solution of cellulose, as described in Borstoel, H., “Liquid crystalline solutions of cellulose in phosphoric acid,” Ph. D. Thesis, Rijksuniversiteit, Groningen, Netherlands, (1998). The resulting LC solution was spun using an air gap-wet spinning technique to obtain highly oriented and crystalline cellulose fibers that had strengths in the range of 1700 MPa.

The resin can include additional non-soluble strengthening agents of natural origin that can be a particulate material, a fiber, or combinations thereof. The non-soluble strengthening agent may be, for example, a liquid crystalline (LC) cellulose nanoclay, microfibrillated cellulose, nanofibrillated cellulose.

Gellan, a linear tetrasaccharide that contains glucuronic acid, glucose and rhamnose units, is known to form gels through ionic crosslinks at its glucuronic acid sites, using divalent cations naturally present in most plant tissue and culture media. In the absence of divalent cations, higher concentration of gellan is also known to form strong gels via hydrogen bonding. The mixing of gellan with soy protein isolate has been shown to result in improved mechanical properties. See, for example, Huang, X. and Netravali, A. N., Biomacromolecules, 2006, 7, 2783 and Lodha, P. and Netravali, A. N., Polymer Composites, 2005, 26, 647.

Gellan gum is commercially available as Phytagel™ from Sigma-Aldrich Biotechnology. It is produced by bacterial fermentation and is composed of glucuronic acid, rhanmose and glucose, and is commonly used as a gelling agent for electrophoresis. Based on its chemistry, cured Phytagel™ is fully degradable. In preparing a composition of the present invention wherein cured gellan gum is the sole strengthening agent, Phytagel™ is dissolved in water to form a solution or weak gel, depending on the concentration. The resulting solution or gel is added to the initial soy protein powder suspension, with or without a plasticizer such as glycerol, under conditions effective to cause dissolution of all ingredients and produce a homogeneous composition.

Preferably, the weight ratio of soy protein: strengthening agent in the resin of the present invention is a minimum of about 20:1, about 15:1, about 10:1, about 8:1, about 4:1, about 3:1 and/or a maximum of about 1:1, about 2:1, about 2.5:1, about 3:1 and about 4:1.

The composition may also include a plasticizer. Plasticizers according to the present invention include glycerol, sorbitol, xylitol, manitol, propylene glycol, as well as any oils or fatty acids. Plasticizers are known in the art. Preferably, plasticizers are biodegradable, from a renewable source and are non-toxic. The weight percentage of plasticizer in the resin (excluding water) is a minimum of about 5 wt. %, about 8 wt. %, about 10 wt. %, about 12 wt. % or about 15 wt. % and/or a maximum of about 20 wt. %, about 18 wt. %, about 15 wt. %, about 12 wt. % or about 10 wt. %.

The biodegradable polymeric composition of the present invention preferably is substantially free of a starch additive. The biodegradable polymeric composition is substantially free of supplementary crosslinking agents such as, for example, acid anhydrides, isocyanides and epoxy compounds.

### Method of Making Resin

A biodegradable resin in accordance with the present invention may be prepared by the following illustrative procedure:

Into a mixing vessel at a temperature of about 70-85° C. is added 50-150 parts water, 1-5 parts glycerol, 10 parts soy protein concentrate or isolate, and 1-3 parts gellan, agar agar, agar or mixtures thereof. To the mixture is added, with vigorous stirring, a sufficient amount of aqueous sodium hydroxide to bring the pH of the mixture to about 11. The resulting mixture is stirred for 10-30 minutes, and then is filtered to remove any residual particles. Optionally, clay nanoparticles and/or cellulose nanofibers, nanofibrils (NFC) or micro fibrils (MFC) may be added to the resin solution as additional strengthening agents.

### Method of Making Molded Articles

The resin solution so produced is used to impregnate and coat one or more fiber mats or fabric sheets. The mats may comprise, for example, kenaf, burlap, sorghum, flax, ramie, sisal, kapok, banana, pineapple, hemp fiber or combinations thereof. In one embodiment, the fabric sheet is preferably flax. The mat is preferably jute or kenaf.

Resin solution is applied to a fiber mat or sheet in an amount of about 50-100 ml of resin solution per 15 grams of fiber so as to thoroughly impregnate the mat or sheet and coat its surfaces. The mat or sheet so treated is precured by drying in an oven at a temperature of about 35-70° C. to form what is referred to as a prepreg or a premolded article. In one embodiment, the prepreg or a premolded article is dried at a pressure that is a maximum of 0.9 atm. The low pressure aids in removing water faster from the impregnated sheets. As needed, the prepreg sheets are potentially impregnated a second time and dried according to one or more conditions described above.

The prepreg mats are arranged into sheets of sufficient size (thickness) and are layered on top of one another. In one embodiment, the first plurality of prepreg mats and the second plurality of prepreg mats require a minimum of about 2 prepreg sheets, about 3 prepreg sheets, about 4 prepreg sheets, about 5 prepreg sheets and/or a maximum of about 10 prepreg sheets, about 8 prepreg sheets, about 7 prepreg sheets, about six prepreg sheets. When stacking the plurality of prepreg sheets care should be taken to prevent any folding of the sheets.

The prepreg sheets are sized to exceed recommended dimension by a minimum of 1 cm in length and width of the desired article. Through experience it has been found that manufacture of a composite board of uniform thickness of a size greater than about 4 feet in length and two feet in width requires assembling pieces that are slightly oversized. Otherwise, the edges of the board may not be made with uniform thickness desirable in a building product.

In one embodiment, the prepregs are cured on contoured precuring racks or premolds. The contoured precuring racks are a three-dimensional shape that is the general shape of the mold. While impregnated with resin, the sheets or mats are wet and more easily stretched or contoured to the desired shape. Sheets of fabric can be cut into desired shapes to ensure that the overall article, when pressed will have the desired thickness and shape. Portions of the fabric whose thickness may be mitigated by forming it in the precured rack can be reinforced by additional sheets of fabric. Portions of the three dimensional prepreg that may have excessive material can be cut, shaped and layered so that the final product does not have folds, creases or excessively thick portions. The fold or creases from bunched fabric are believed to cause weaknesses in the final molded product. Additionally, large variations in the thickness of an article from part of a panel to another may be aesthetically unpleasing in certain applications. By general shape, it is meant a shape that when molded will prevent the fabric from creasing or folding during the final molding process.

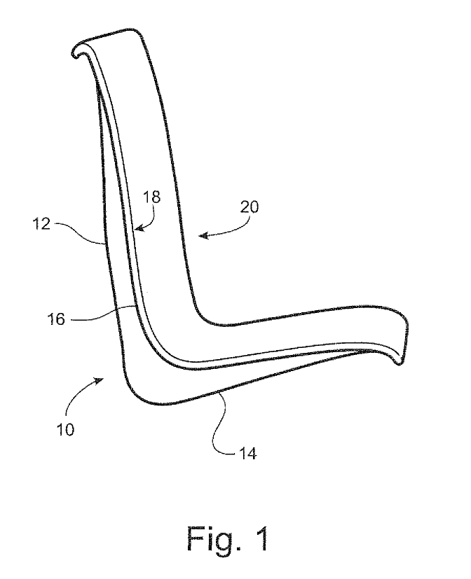

In one embodiment, a precured rack is described to form a contoured article such as a bucket seat 10 shown in FIG. 1. The bucket seat 10 has a rounded back 12, and a curved seated portion 14 that contours the back and thighs of a person using the seat 10. Additionally, a curved edge 16 surrounds the perimeter of the chair to improve comfort an add strength. The chair 10 is designed to be mounted on a bench or single chair leg stand (not shown). The sides 18 and 20 of the bucket seat are elevated providing support to the back 12.

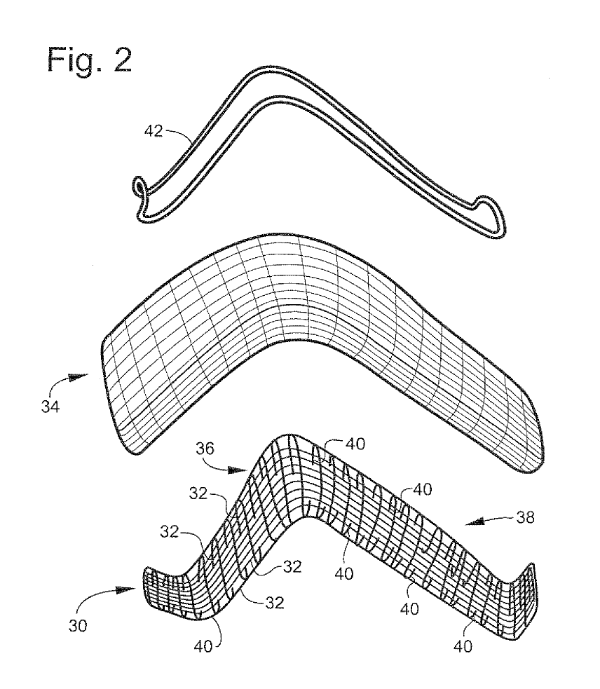

When molding this article, flat precured sheets of soy based resin composites may deform, bunch and fold creating weaker and thicker portions of the object. With reference to FIG. 2, a contoured precuring rack 30 is made for a bucket seat. The rack 30 is not a mold but a “pre-mold” that receives wet, woven or non-woven impregnated mats 34 (shown prior to curing) that is somewhat more malleable and will more readily form to the desired shape than impregnated mats that are precured in a flat shape. The rack 30 is made of wire 32 to allow drying air to flow through the one or more impregnated mats 34. The wet impregnated mats 34 are laid over the precuring rack 30.

The precuring rack of one embodiment for forming a bucket seat is described with continued reference to FIG. 2. The seat-forming surface 36 is on one side of the precuring rack 30. The back forming surface 38 is generally on the other side of the precuring rack 30. The precuring rack 30, of one embodiment, is not simply a flat angled member but forms at least a portion of the contour of the final product on surfaces 36 and 38. A lip 40 is formed on the precuring rack 30 around the outside edge of where the bucket seat will be formed. The lip 40 will contain the excess impregnated fiber that will later need to be trimmed to shape.

A top rack 42 is optionally employed to help the shape molded member take its general shape when the general shape is sufficiently complicated to make. In this embodiment, the top rack 42 is a wire that goes around the perimeter to ensure that the lip is adequately pre-formed. One or more impregnated sheets 34 are placed over the mold in wet state. In the present embodiment, the gravitational force of the wet impregnated sheets 34 is expected to be sufficient to form the desired general shape of the bucket seat. As needed, reinforcement sheets (not shown) may be added to seat and back portions that are deemed to need structural reinforcement. The reinforcement sheets are placed over a region that needs enhanced strength or stiffness.

It is not necessarily intended that the precured mats 34 conform exactly to shape of the press mold (not shown) used for press molded curing. However, the impregnated mats 34 are preferably precured into the general shape of the heat pressed mold to the extent that when the sheet is molded, it can be accomplished without defects due to bunching or creasing during the heat pressing process.

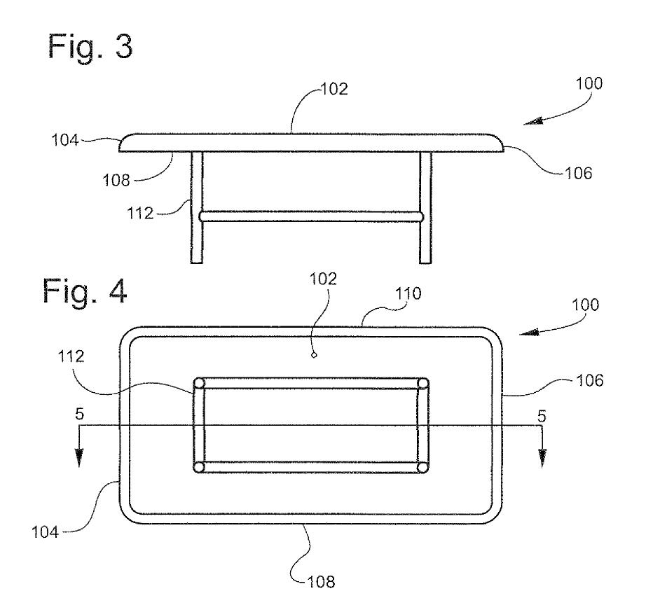

With reference to FIGS. 3-5, one embodiment of the present invention makes a table surface 100 that is made according to one or more embodiments of the present invention. The table surface 100 has a generally flat surface 102 with downturned edges 104, 106, 108 and 110 on all sides of the table. The downturned edges are press molded resembling, for example, a round edge such as one that would be created when a round over router bit is used to edge a solid table surface. The downward turned edges 104, 106, 108 and 110 are designed to reinforce the strength of the table 100, by resisting bending of the table top surface 102 in the direction of the downturned edges 104, 106, 108 and 110. The table sits on a leg frame 112.

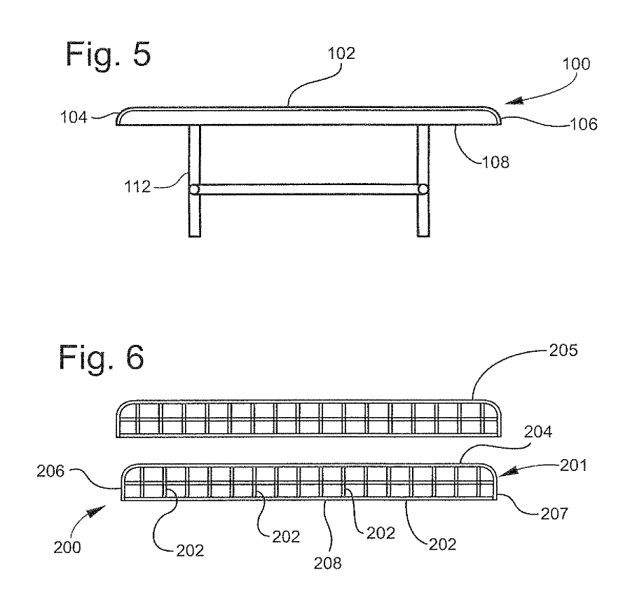

FIG. 4 shows an underside view of the table surface of FIG. 3. The underside view better shows the contour of the table and the downturned edges 104, 106, 108 and 110. The leg frame is also in view. FIG. 5 shows a cutaway view of the table shown along the lines 5-5 of FIG. 4. Downturned edges 104 and 106 are shown in view.

FIG. 6 shows one embodiment of a precuring rack 200 for making the prepreg of the table of FIGS. 3-5 above. The bottom rack 201 is made of a purality of wires 202 forming a wire frame 202. The wires 202 have a generally flat supporting portion 204 that is downturned along the edges 206, 207 and 208 that are the same or similar to the downturned edges that are desired on the resulting table described above. When wet soy resin impregnated sheets (not shown) are laid over the rack, they generally form the shape that will be desired for the table.

The wire frame 202 allows air to circulate to the drying impregnated mats (not shown). When wet impregnated mats (not shown) are laid over the bottom rack 201, they take the general form of the bottom rack 204. However, optionally, a top rack 205 can be used to provide additional weight to assist in shaping the downturned edges of the drying impregnated sheets (not shown).

After the precured sheets are dried during the precuring step, the precured sheets whether formed in a flat or contoured shape (collectively “prepregs”) are taken and placed in the mold. The prepregs in the contoured precuring rack are in one embodiment layered to produce the desired thickness in the mold. In another embodiment, the prepregs are layered on the precuring rack so that a single piece prepreg is placed in the mold.

Thereafter, one or more of the prepregs are stacked as described above and is subject to high pressure and temperature to cure. By way of example, the stack is hot pressed for 2-10 minutes at about 80° C. and a pressure of 0.5-1 MPa. Following a rest period of about 5 minutes, the stack is hot pressed for 5-15 minutes at 120-130° C. and a load of 2-10 MPa, followed by removal from the press. The resulting shape molded article has the appearance of the bucket seat and a thickness of about 5 mm with slightly thicker portions where reinforcement is needed. Then, the outer perimeter of the shape-molded thermoset article, typically, is cut to the desired size. The edge, generally, is sanded and polished.

Also in accordance with the present invention, a biodegradable shape-molded thermoset polymeric article is obtained by subjecting the biodegradable polymeric composition described above to conditions of temperature and pressure effective to form the thermoset shape molded polymeric article. Effective temperature and pressure conditions preferably comprise a temperature that is a minimum of about 35° C. and a maximum of about 130° C. and a pressure that is a minimum of about 0.1 MPa and a maximum of about 20 MPa, more preferably, a temperature that is a minimum of about 80° C. and a maximum of about 120° C. and a pressure that is a minimum of about 2 MPa and a maximum of about 20 MPa.

In one preferred embodiment, the molded thermoset polymeric article comprises a contoured prepreg article that may be formed into a contoured shape-molded thermoset biodegradable article.

Preferably, the biodegradable press-shaped thermoset polymeric article is characterized by stress at maximum load of at least about 20 MPa and/or a modulus of at least about 300 MPa.

In one embodiment, the shape molded articles have excellent nail and screw retention properties, can be painted effectively and are strong. They can be cut or drilled without frayed edges and are consistent in width throughout the surface area. In another embodiment, the shape molded articles are for vehicle parts such as an automobile. Typically, the shape molded articles include but are not limited to side panels, roof panels, dashboards, door panels and panels to shape the trunk of a car.

In one embodiment, the molded articles are coated with a waterproofing agent. Preferably, the waterproofing agent is biodegradable, non-toxic and/or does not harm the environment. The product can easily be coated with a coating of any color, a latex, polyurethane or oil based paint. The object may be coated with oils such as linseed oil, tung oil, shellac and other natural coatings.

In one embodiment of the present invention, one or two surfaces of the contoured article is laminated with a veneer or coated to improve water resistance. The veneer can improve appearance as well as water resistant properties of the corrugated board. The veneer of one embodiment is a wood veneer, or printed paper veneer. The veneer may be laminated or coated to produce a waterproof finish. The coating of one preferred embodiment incorporates a natural whey ingredient to improve its earth friendly properties according to formulas known in the art. In another embodiment, the coating is not a biodegradable coating. For example polyurethane or epoxide coatings are used to cover the surface of the corrugated board. In another embodiment, Formica is the laminated outer layer. While it is understood that non-biodegradable materials are less desirable from an ecological standpoint, the use of petroleum products on the outer layers is often worthwhile for furniture or other objects to produce a long-lasting durable product where the bulk of that product is made from renewable and biodegradable materials.

### Example

### Manufacture of a Snowboard with a Soy Composite Core

Snowboards are usually constructed with a laminated wood core sandwiched between multiple layers of fiberglass. The bottom or ‘base’ of the snowboard is generally made of various constructions of plastic such as polyethylene or polypropylene, and is surrounded by a thin strip of steel, known as the ‘edge’. The top layer, where a printed graphic usually resides, is usually made of acrylic. The wood core varies in hardness from tip to deck to tail. The selection of the wood of differing density and the relative positioning along the length of the snowboard determines the amount of flexibility at particular point along the length of the snowboard. Selection of a balsa wood will result in high flexibility. Selection of a hardwood will result in greater strength and stiffness. It is desirable in one application to have greater stiffness in the deck portion of the snowboard and greater flexibility towards the tip and tail.

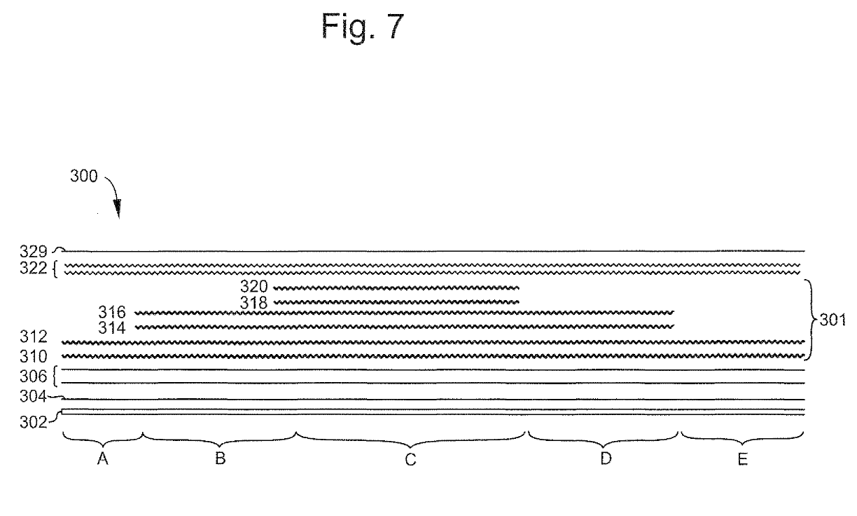

One embodiment of the present invention that discussed with reference to FIG. 7 shows an exploded view of a snowboard 300. The snowboard 300 includes a bottom layer 302 made typically of extruded or scintered polyethylene. It is premolded to the desired shape of the bottom layer 302. Immediately above the bottom layer 302 is a design print layer 304. The design print layer 304 is visible through the bottom layer 302. Above the design print layer 304, is a bottom fiberglass layer 306. Preferably, the bottom fiberglass layer 306 has between one and four layments of fiberglass sheets. Most preferably, the fiberglass layer 306 has two layments of fiberglass sheets.

The core 308 is placed directly above the bottom fiberglass layer. The core 308 defines the relative flex or stiffness at different locations along the length of the board. The core 308 of the present embodiment is made of multiple layments of woven or non-woven fabric mats or sheets that were impregnated with soy protein resin and precured into a sheet format according to one embodiment of the present invention. The parts along the length of the snowboard where greater flexibility is desired relatively fewer layments of impregnated, precured mats and sheets are required. In parts along the length of the snowboard where greater rigidity is desired, relatively more layments of impregnated mats are used. It will be appreciated by a person of ordinary skill in the art that the specific positioning of the various layers of mats are within the skill or an ordinary artisan.

In the present embodiment, the length of the snowboard 300 is divided into five regions labeled A-E. Region A is the tip region. Region B is the front intermediate region. Region C is the deck where the binding is likely to be fastened. Region D is the rear intermediate region. Region E is the tail.

The first layment 310 is a prepreg mat made of nonwoven plant-based fibers that are outlined in the present application. Preferably, kenaf, hemp jute, or sorghum fibers are selected for the mat. The first layment 310 is a nonwoven mat. Prior to compression, the mat is approximately 3-5 mm in thickness. The first layment 310 extends the length of the board. The second layment 312 also extends the length of the snowboard 300 and is made of a similar material. The third and fourth layments 314 and 316 respectively extends the length of the front and rear intermediate sections and deck.

A fifth 318 and sixth 320 layment extend the length of the deck. The arrangement is designed to provide considerable flexibility in the tip and tail sections and stiffness in the deck section. The soy protein resin has excellent binding properties to other materials including the fiberglass. However, it is understood that if any layer needs additional adhesive, it is within the ability of a skilled artisan to select from a wide range of adhesives.

A top fiberglass layer 322 consisting of two fiberglass layments are placed above the core and extend the length of the board 300 from the tip to the tail. A final artwork layer 324 is placed over the fiberglass layer. The top layer is acrylic (not shown). It is applied after the other layers are pressed together. It provides strength and a glossy finish to the snowboard 300.

The snowboard board 300 is assembled by stacking these layers in a press. The press is configured to compress the core so that the pressure of the deck is greater than the compression at the tip and tail of the board due to the variance in the number of core layers provided. The board is compressed into an acceptable contoured design. For example it has an upturned tip and tail and a camber in the deck region. Once the snowboard 300 is completely pressed, it is cut into the desired shape and fitted with an edge, typically made of steel.

While the invention has been described by reference to various specific embodiments, it should be understood that numerous changes may be made within the spirit and scope of the inventive concepts described. Accordingly, it should be recognized that the invention is not limited to the described embodiments.

What is claimed is:

1. A contoured press molded article comprising:
a soy-based resin and a plant-based sheet, wherein the article is manufactured from the process comprising the steps of:
impregnating the sheet with soy-based resin;
precuring the sheet to remove water to form a premolded article, wherein at least one region of the premolded article is reinforced with at least one additional layer of impregnated soy-based resin to provide said region with properties of greater strength or stiffness;
pressing the contoured premolded article into a contoured molded article, wherein the contoured molded article has a flexural strength that is greater than 20 MPas.

2. The article of claim 1, wherein the premold is contoured and forms a contoured premold article and further wherein the region defines a curve in the contoured article.

3. The article of claim 1, wherein the region defines an area of anticipated greater flexural wear in the finished product.

4. The article of claim 1, wherein the article will not harm the environment when decomposed.

5. The article of claim 1, further comprising the step of cutting the molded article into its desired shape.

6. The article of claim 1, further comprising finishing the edges of the molded article.

7. The article of claim 1, further comprising coating the article with a water-proofing agent that will not harm the environment when decomposed.

8. The article of claim 7, wherein the step of coating results in a coating of desired color and appearance.

9. The article of claim 1, wherein the step of precuring further includes precuring in a contoured premold to form a precured article, wherein the contoured premold is the general contour of the molded article.

10. The article of claim 1, wherein the resin further comprises a carboxy-containing polysaccharide copolymer.

11. The article of claim 1, wherein the article is a door panel, dashboard, wall panel ceiling panel of a vehicle.

12. The article of claim 1, wherein the article is incorporated into a chair, couch, table, shelf or cabinet.

13. The article of claim 11, wherein the article is a door panel and the region is adjacent the door handle.

14. The article of claim 12, wherein the article is a chair or couch, the region is the area of greatest weight bearing.

15. A method of making a contoured press molded article comprising:
impregnating a plant-based sheet with a soy-based resin;
precuring the sheet to remove water and form a premolded article, wherein a region of the premolded article is reinforced with at least one sheet to impart greater strength or stiffness to the region.
pressing the premolded article into a contoured molded article that has three-dimensional contours, wherein the precured article has a flexural strength that is greater than 20 MPas.

16. The method of claim 15, wherein the article will not harm the environment when decomposed.

17. The method of claim 15, wherein the premold is contoured to produce a contoured premolded article, wherein the region defines a curve in the contoured article.

18. The article of claim 15, wherein the region defines an area of anticipated greater flexural wear in the finished product.

19. The article of claim 15, wherein the resin further comprises a carboxy-containing polysaccharide copolymer.

20. The article of claim 15, wherein the resin is substantially free of starch.
